(19) United States
(12) Patent Application Publication
(10) Pub. No.: US 2003/0084443 A1
(43) Pub. Date: May 1, 2003

(54) System and method for creating program enhancements for use in an interactive broadcast network

(75) Inventors: Matthew Laughlin, Norwell, MA (US); Colin Campbell, Norwood, MA (US)

Correspondence Address: ANTONELLI TERRY STOUT AND KRAUS, SUITE 1800, 1300 NORTH SEVENTEENTH STREET, ARLINGTON, VA, 22209

(73) Assignee: Commerce TV Corporation, Inc.

(21) Appl. No.: 09/985,072

(22) Filed: Nov. 1, 2001

(51) Int. Cl. H04N 5/445; G06F 3/00; G06F 13/00

(52) U.S. Cl. 725/39; 725/47

(57) ABSTRACT

A system and method are provided for creating programming enhancements for interactive commerce in a television distribution network. The system includes databases containing information on available products, layouts suitable for displaying product information on a television screen, and program schedule information. Computer applications allow a user to select a group of products, select and customize a screen layout, and define a program enhancement associating the products and layout with a particular scheduled program. Each program enhancement created with the system is stored for broadcast to viewers on the network at an appropriate time prior to the scheduled broadcast of the particular program with which it is associated. To conserve system resources, basic screen layouts for the enhancements are stored on viewers' set top boxes, and only information relating to the customized features of the enhancement's appearance, such as color and type style, is broadcast.

### FIELD OF THE INVENTION

This invention relates generally to interactive video programming enhancements and in particular to the creation of such enhancements suitable for use in a broadcast television network.

### BACKGROUND OF THE INVENTION

Interactive television is revolutionizing the cable and satellite television industries, changing television viewing from a purely passive experience into one that permits the viewer to participate in a wide range of activities. In a traditional cable or satellite television system, a set top box receives multiple channels of programming content from a cable or satellite television operator, and transmits to the television receiver the specific programming content on a channel selected by the viewer. The transmission of information occurs in one direction only, from the cable operator, via the set top box, to the television receiver for viewing by the viewer. In an interactive television system, by contrast, the cable distribution system supports an Internet-style two-way TCP/IP data link in addition to the regular broadcast channels, allowing the viewer to send messages over the network back to the cable head end in response to the programming or to informational messages sent with the programming. In such interactive systems, the set top box also functions as a digital computer, and is able to store and run application programs that permit two-way communications between the viewer and the cable operator, as well being able to support a variety of other interactive functions such as video games, virtual VCR capabilities and the purchasing of products and services.

It has been common in conventional one-way broadcast systems to deliver informational messages to viewers independently of any programming content, such as in the case of severe weather warnings or late-breaking news. However, conventional broadcast systems are increasingly delivering informational messages that are directly related to the program being broadcast. A very common example is closed captioning. Closed captioning is a service that uses the vertical blanking interval (VBI) of a conventional analog video signal to transmit digital data, in this case text, to the television receiver, where it is decoded and displayed to the viewer with its related programming.

In interactive television, an informational message is sent to the viewer with the intent of eliciting a response, most often in conjunction with the particular program to which the message relates. In interactive commerce, a viewer may, for example, be given the opportunity to indicate his or her desire to receive marketing or promotional materials or samples of a particular product or service being advertised on that program, or even to purchase such products and services. Viewing the information message in conjunction with a related program creates a sense of immediacy or urgency that increases the likelihood of the viewer responding to the message.

If an interactive system is used for television commerce, it is critical that the pre-recorded messages, or other similar program “enhancements”, be displayed to the viewer at the appropriate point within the associated program. If, for example, the intention of an enhancement is to solicit the viewer's interest in receiving a glossy brochure on a particular automobile during a commercial for that same automobile, then it is important that this enhancement be displayed during the typical 30-second duration of such a commercial. Seeing the enhancement after the commercial has ended and the sleek, gleaming vehicle is no longer visible on the screen, the viewer's excitement and interest in the vehicle may have already faded and a response, therefore, less likely. Thus, the enhancement delivery system must ensure that enhancements are available for display at the set top box when they are needed.

On-air closed captioning, mentioned above, is one example of the various techniques have been developed over the years for delivering informational messages to television viewers. Another example is a proposed system in which a viewer uses an identifier transmitted with a television program to request a server at the cable system head-end to download related information from an Internet website. This approach can be called a “pull” system because in order to receive the informational message, the viewer must request and “pull” it from a server remote from the set top box. However, this approach fails to adequately take into account the limitations on the speed at which enhancements can be transmitted to viewers over a television programming network, particularly one using analog technology. The size of an enhancement for television commerce, which can include images as well as text, may be such that it would not be available in a timely fashion if it were to be down-loaded from a broadcast station or cable head-end while the related program segment is already in progress. It would be advantageous, instead, to use a “push” system that broadcasts program-related enhancements to set top boxes in advance and triggers their activation later at the appropriate time during the related programming segment or commercial.

Current set top box technology also imposes other limitations on what can be done in terms of program enhancements intended for use in a television commerce application. For example, set top boxes usually have a more limited graphics capability than personal computers. There are generally restrictions on the shapes and colors of objects that can be rendered by a set top box. In addition, set top boxes do not typically provide for mouse or keyboard inputs, so enhancement layouts have to be capable of being navigated with the buttons on a typical TV remote control. Any system developed for creating enhancement layouts must take these limitations into account.

Most current set top boxes also have memory limitations, and as earlier noted, digital transmission rates in television distribution networks are somewhat constrained. Combined, these factors make it is essential that enhancements for television commerce require transmission and storage of the minimum amount of data necessary to produce on-screen displays of acceptable appearance. Also, the operating systems of set top boxes obtained from different manufacturers often employ different programming languages. Ideally, enhancements should be broadcast in a single format that is widely supported and compatible with the various set top box operating systems that are currently in use or likely to be used in the near future.

### OBJECTIVES

Therefore, it is an object of the present invention to provide a system for creating programming enhancements suitable for interactive commerce in a network using television sets and set top boxes.

It is another objective of the present invention to facilitate the creation of programming enhancements with a customized look and feel for a broad variety of products, and targetable to diverse markets.

It is a further objective of the present invention to provide for the creation of programming enhancements that make efficient use of the limited data transmission and storage resources of a broadcast television distribution system.

It is yet a further objective of the present invention to provide for delivery of programming enhancements in a commonly accepted format compatible with a wide variety of set top boxes.

The above-stated objectives, as well as other objectives, features and advantages, of the present invention will become readily apparent from the following detailed description, which is to be read in conjunction with the appended drawings.

### SUMMARY OF THE INVENTION

The present invention is directed to the creation of program enhancements for use in an interactive broadcast television network. Particularly, the enhancements must be suitable for display on a television screen. A system embodiment includes a first database containing information on available products, a second database containing information relating to a plurality of layouts suitable for displaying product information on a television receiver screen, and a third database containing schedule information relating to television programs to be aired on the television network. A processor, running software programming called the EBG (Electronic Buying Guide) application, allows a user, through a series of user inputs, to select from the first database a group of products having a relationship to a particular scheduled program, to select one of the screen layouts from the second database, and to extract from the third database, schedule information relating to the channel, date and time of the particular program. The resulting output is an enhancement definition that forms an association between the selected group of products, the one selected screen layout, and the extracted schedule information.

The EBG application provides a convenient graphical user interface to receive the user's inputs with respect to the selection of information from the first, second and third databases. The user interface includes a plurality of user-selectable screens for entering the user inputs.

Another aspect of the present invention involves the features of the screen layouts. At least one of the screen layouts that can be selected from the second database, includes facility for displaying a list of the selected group of products. Preferably, the one screen layout also includes facility for displaying, in either pictorial or text form, or both, detailed information about an item the television viewer can select from the displayed list of products.

Another layout feature that can be added according to the present invention is a group of logos to identify a programming source (e.g., a network such as ABC or NBC), a broadcast system operator (typically a cable operator) and a product vendor. Preferably, the logos are arranged in a so-called “branding bar” that would appear with the enhancement at the bottom of the television screen.

In another aspect of the invention, the enhancement definition created by the EBG application is a list of data files containing detailed information about the selected group of products, associated screen layouts and programming program schedule information, such that the data in the files is sufficient to enable an enhancement, conforming to the enhancement definition, to be displaying on the viewer's television screen. Preferably, these detailed data files are output by the processor with the enhancement definition so that they are available to be broadcast to the viewer.

In another aspect, the present invention allows the user to select additional scheduled programs with which enhancement is associated, and to include the relevant schedule information for these additional programs in the enhancement definition. Thus, a single enhancement definition can cause the enhancement to appear on different channels and at different dates and times. The present invention also allows the user to select the geographic region in which a program enhancement is broadcast, by associating it with a channel on a particular cable system head-end or group of head-ends

In a further aspect of the present invention, a second processor directs the broadcast of the enhancement to a network terminal, at a time prior to the scheduled broadcast time of the television program with which the enhancement is associated. The network terminal receives the television program and enhancement and displays the enhancement with the associated program to a television viewer, giving the viewer an opportunity to respond to the information in the enhancement.

Typically, the network terminal will be an advanced analog or digital set top box of the type commonly used in cable television distribution systems. However, the method of the present invention can be successfully implemented by incorporating the functionality of the set top box into the television set or other appliance used to display the broadcast program.

Preferably, the second processor causes the enhancement to be broadcast on the same channel on which the associated program is scheduled to be broadcast, so as to assure receipt by the set top box. In the preferred embodiment, the broadcasting process is handled by a software application called the Data Streamer System (DSS), running on a processor at the broadcast network head end. In an analog television system, the DSS preferably broadcasts the enhancement via the vertical blanking interval (VBI) of the analog television signal.

In a further aspect of the invention, the second processor converts the program enhancement into an XML (Extensible Markup Language) document prior to broadcast, and the viewer terminal is capable of converting the XML-formatted information into a form suitable for displaying to the viewer.

In the preferred embodiment of the present invention, the screen layouts stored in the second database include a relatively limited number of basic layouts that can be modified (i.e., customized) using a software application, called the Layout Authoring Tool, running on a processor. The Layout Authoring Tool provides a graphical user interface, having a plurality of user selectable screens, for receiving user inputs with respect to modification of the basic layouts. Preferably, the layout information included in a broadcast program enhancement includes only the identity of the basic layout from which the modified layout is derived, and information regarding the layout feature parameters that have been modified. Preferably also, the network terminal already has stored within it the essential features of each layout, and is configured to be able to display the enhancement in the customized layout, based on the limited layout information received.

As discussed above, features of the basic screen layouts preferably include a list of available products and the facility to display detailed information in pictorial and text form, relating to the items on the list. Preferably, the screen layouts are translucent so as not to obscure the underlying television programming material, and occupy only the bottom one-third of the screen. The modifiable parameters of the layout features include color and type style, giving each customized layout a sufficiently distinctive look and feel without requiring a large amount of layout information to be broadcast to the network terminal.

The preferred embodiment described herein contemplates use of a number of processors and databases in a distributed architecture running the software applications that provides a functionality of the present invention. However, a different hardware architecture can be employed to practice the invention with equivalent effect.

### BRIEF DESCRIPTION OF THE DRAWINGS

FIGS. 1A-1B show a system for creating and delivering programming enhancements in a interactive television system in accordance with the present invention;

FIG. 2 shows an example of a television program enhancement that can be created and delivered with the present invention;

FIGS. 3A-3D show screen shots of the Layout Authoring Tool used to customize enhancement screen layouts according to the present invention;

FIGS. 4A-4F show screen shots of the EBG application used to define EBG masters according to the present invention;

FIG. 5 shows the structure of an EBG master according to the present invention;

FIG. 6A shows a functional block diagram of the Data Streamer System used to broadcast enhancements according to the present invention;

FIG. 6B shows the structure of an enhancement data package broadcast by the Data Streamer System; and

FIG. 7 is a flow chart of the method for creating and delivering programming enhancements according to the present invention.

### DETAILED DESCRIPTION OF THE INVENTION

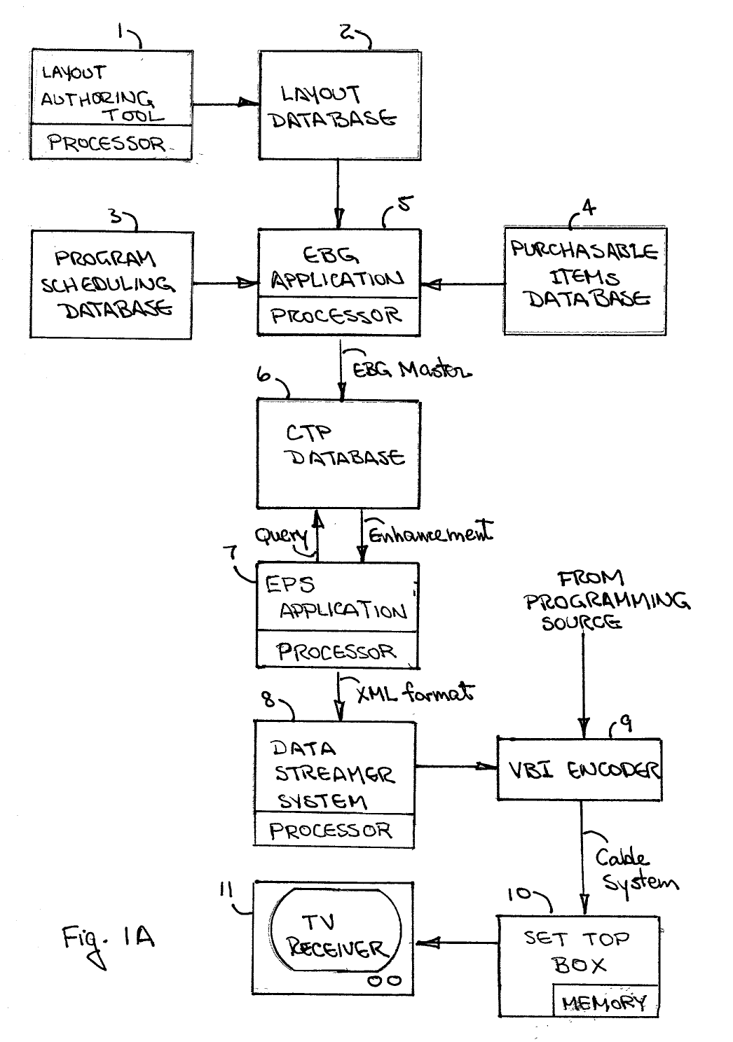

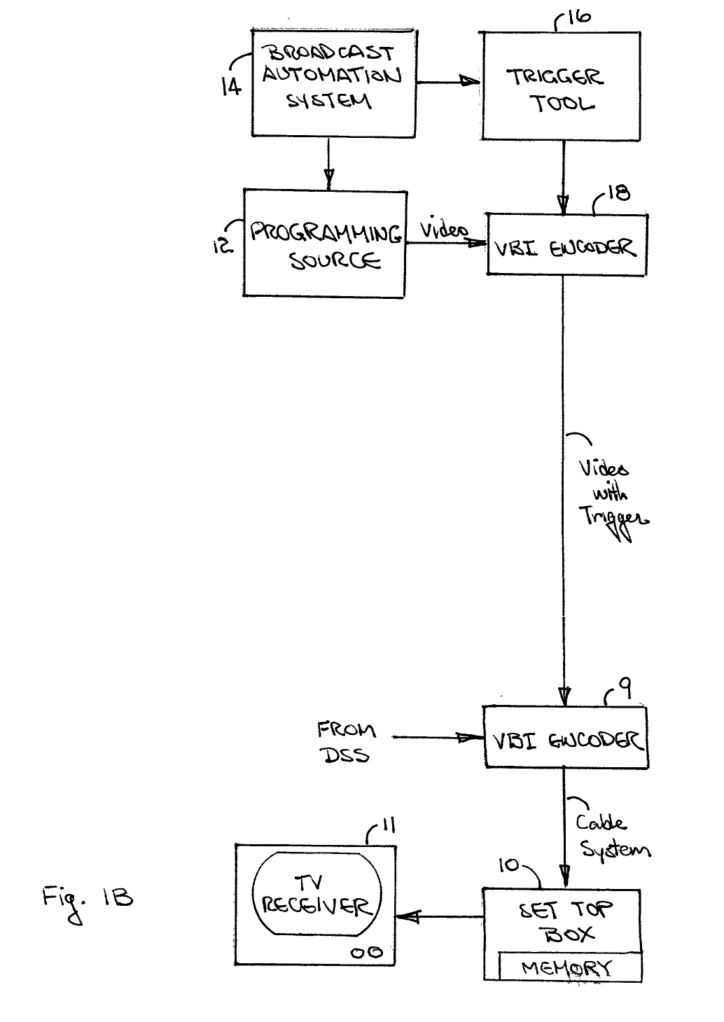

FIGS. 1A-1B show in block diagram form the preferred embodiment of the present invention. Referring to FIG. 1A, the Layout Authoring Tool (LAT) 1 represents the first step in creating broadcast program enhancements for interactive commerce. The authoring tool creates layouts that are filled later in the process with graphic and textual product information to form complete enhancements.

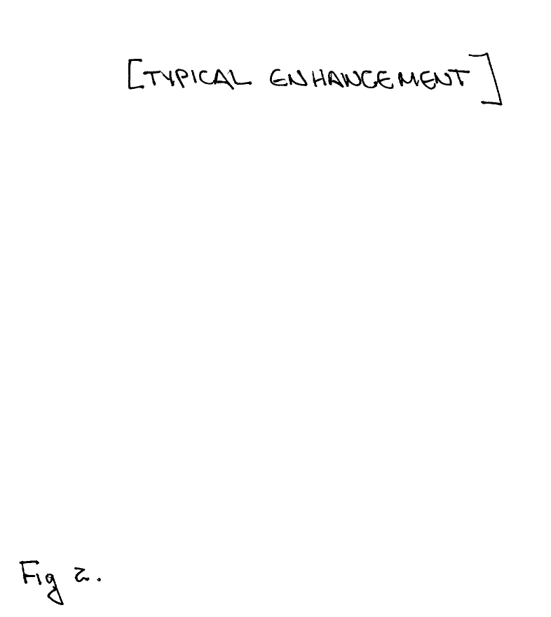

The layouts created by the Layout Authoring Tool are specifically intended for presenting product information on a television screen. The layouts tend to be simpler than those that might be presented on a computer screen because of the more limited graphics capabilities generally available in television set top boxes. A typical television program enhancement is shown in FIG. 2. The enhancement forms an overlay on the current television programming and serves as the viewer's initial contact with the interactive commerce system. The enhancement is preferably translucent and covers only about one-third of the screen, so as to minimize blockage of the underlying television programming. The principal features of the enhancement shown are the list of available products (no.), logo (no.), branding bar (no.) and response buttons (no.). The graphics box (no.) and text box (no.) provide additional information about any item on the list selected by the viewer. Using the response buttons (no.), the viewer can request detailed information about a selected item, save an item in a list of favorites for later consideration, or initiate an interactive purchase sequence.

The Layout Authoring Tool is a software application with a graphical user interface that offers the user a menu of basic layouts, typically about five in number, each of which may be customized in certain respects for the networks and broadcasters and that will be using them. In general, the basic size and placement of the different features in each layout, such as lists, graphic windows and buttons, are predetermined and not alterable. On the other hand, the user can modify some of the parameters of the features, such as colors, fonts, shading, transparency and button labels, to give the enhancement a customized appearance.

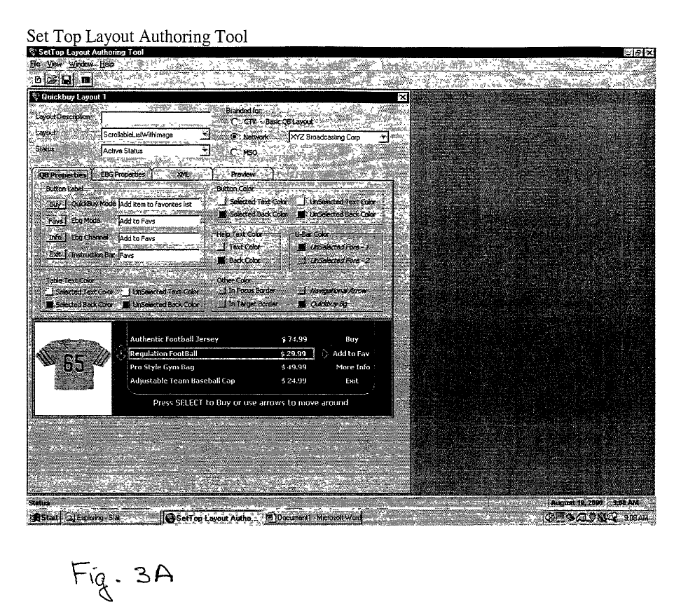

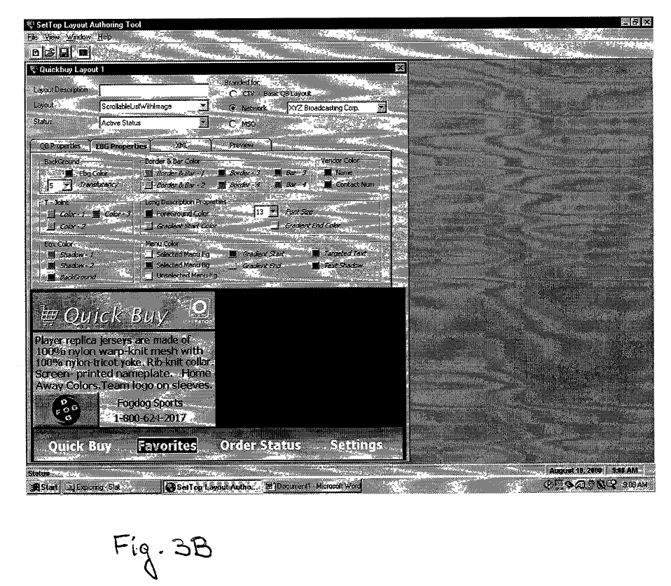

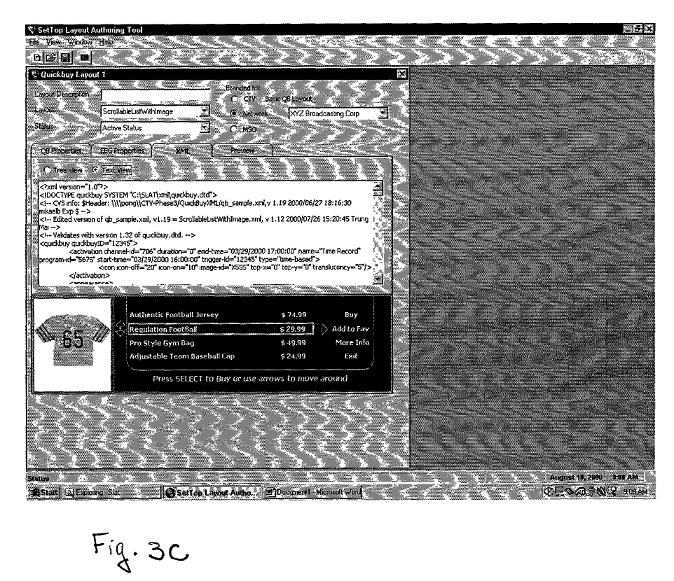

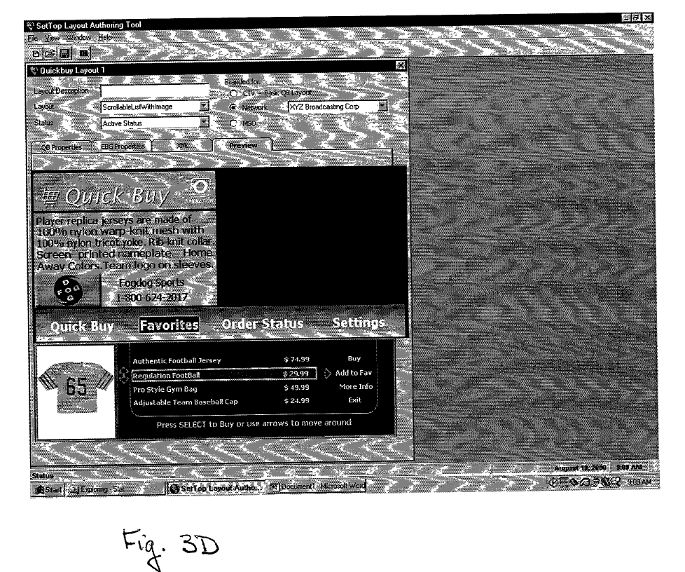

The LAT's user interface, shown in FIGS. 3A-3D, permits the user to select one of the basic layouts from a menu and associate the layout being customized with a particular network or multiple system operator (MSO). This association will, as discussed below, be useful in the later process of preparing complete enhancements.

The user interface has a number of selectable tab screens that allow the user to modify certain parameters of the selected layout's features. FIG. 3A, for example, shows the QB Properties screen. A QB, or Quick Buy, layout (sometimes also referred to as an “impulse” layout) is a simple layout that is generally limited to a scrollable list of products and a small picture frame to illustrate a product selected from the list. The products and pictures shown are just examples provided by the Layout Authoring Tool. In FIG. 3A, the parameters that can be modified are limited, and include feature colors and labels.

FIG. 3B shows the EBG Properties screen. The EBG, or Electronic Buying Guide, is a class of layouts that can provide more complete information about a selected product. In the example, the highlighted product is a football jersey. The EBG layout provides, in addition to the product picture, a text box for displaying further information as text. In addition, there are a larger number of parameters, such as text, border and bar colors, font size and background transparency, that may be modified.

The XML screen illustrated in FIG. 3C allows the user to review the XML code that is generated by the LAT from the user's inputs. However, the code, which can at the option of the user, appear either in logic tree or text form, cannot be directly altered by the user.

FIG. 3D shows the Preview screen, which illustrates for the user how the modified layout will appear before the user decides to save it to the layout database 2.

The number of basic layouts has been limited in the preferred embodiment to minimize the amount of layout information that must be sent to the set top boxes with each enhancement. The features of the basic enhancements are stored in the set top box as part of a software application that supports the display of the enhancements to the viewer. Therefore, only the selectable feature parameters, such as colors and type fonts, need to be broadcast in order to display a customized layout. To be commercially acceptable, the system must address viewers that have the least capable equipment. With existing technology, it was determined that about five basic layouts could be effectively supported in this manner. As set top boxes and data transmission rates in television distribution systems generally improve, the number of layouts and selectable parameters can be increased accordingly.

Limiting the users choices in basic layouts and modifiable features also has the benefit of making the authoring process simpler and faster. Even users with little skill or experience should find the authoring tool user friendly.

The output of the authoring tool is a layout definition in the form of an XML (Extensible Markup Language) document. XML is a language capable of efficiently representing the layout definition in a manner compatible with a variety of different platforms. The software application running on each set top box to support interactive commerce will include an XML reader, or decoder, to take the layout definition in XML and convert it into a graphical representation of the layout consistent with the language used by the particular set top box operating system. For example, Scientific Atlanta set top boxes run under C++ language, while General Instruments set top boxes use HTML.

The layouts created by the authoring tool are also designed to accommodate the limited on-screen navigation capability of presently available set top boxes. Set-top boxes typically use no mouse or keyboard, relying on the TV remote control as an input device. As a result, navigation is limited to using buttons on the remote control to move step-wise through a sequence of choices on the television screen in either an upward or downward direction, or left or right. Navigation techniques familiar to computer users, such as “point and click” and “drag and drop”, are not available with a set-top box and remote control.

Continuing with reference to FIG. 1A, the set top box layouts created with the layout authoring tool 1 are stored in the layout database 2, where they are available to the EBG (“Electronic Buying Guide”) application 3. The EBG application also draws from information stored in the program scheduling database 4 and the purchasable items database 5. The role of the EBG application is to select data from these three databases that together will define each of the program enhancements. The program scheduling database 3 contains information from a third-party vendor, such as TVData of Glen Falls, N.Y., that includes a file of the planned daily program schedules for each channel into which enhancements may be inserted. The data in the schedule file relates each program, identified by program name and ID number, to a channel ID, program start time and duration. Other files in the program scheduling database 3 relate each channel ID to the head end of the cable system with which the channel is associated, and identify the multiple system operator (MSO) with which the head end is associated. The data received from the third party vendor also contains zip code and location information associating each head end with a specific geographical area. After downloading program scheduling data for a specified initial period of time, preferably about 60 days, the vendor provides daily updates to the programming data including schedules for one new day of programs and corrections to schedules already received.

The program scheduling database can also be accessed manually for adding, deleting or modifying schedule information. This capability is most important in the case of scheduling program segments and commercial messages, which do not appear on commercially available television schedules.

The database of purchasable items 5 provides the names and other information, such as price, size and color, relating to items that may be purchased using the system. In addition to information about individual items, database 5 typically contains lists of purchasable items that have been previously prepared in connection with enhancements for particular programs or advertisers, and that may be reused or modified for new enhancements.

The EBG application 5 is a software-driven process that goes through a series of steps to create a “EBG master” for each enhancement. The EBG master defines all of the elements the complete enhancement will require. The EBG application provides the user with a series of screens that allow the user to create the EBG master using the information from the layout database 2, the purchasable items database 4, and programming scheduling database 3. For each enhancement, the user must select a basic or customized layout, create a list of purchasable products related to the enhancement, and associate the enhancement with a specific program time slot.

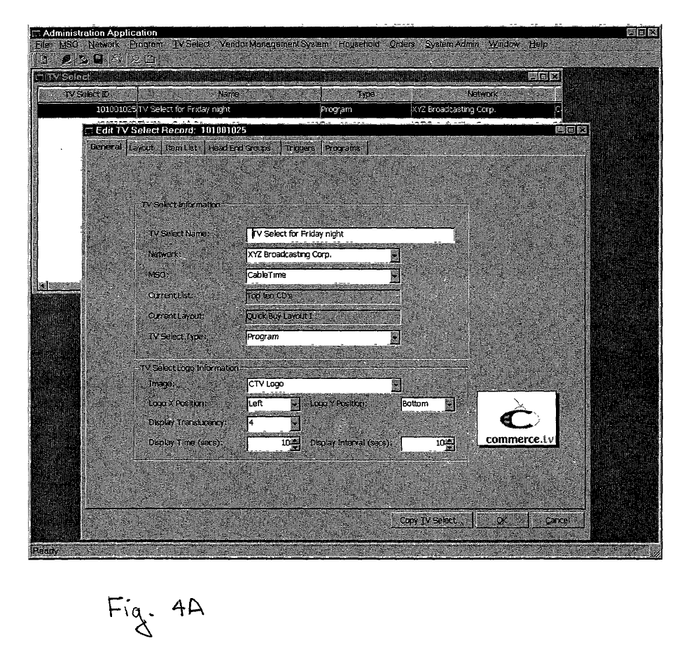

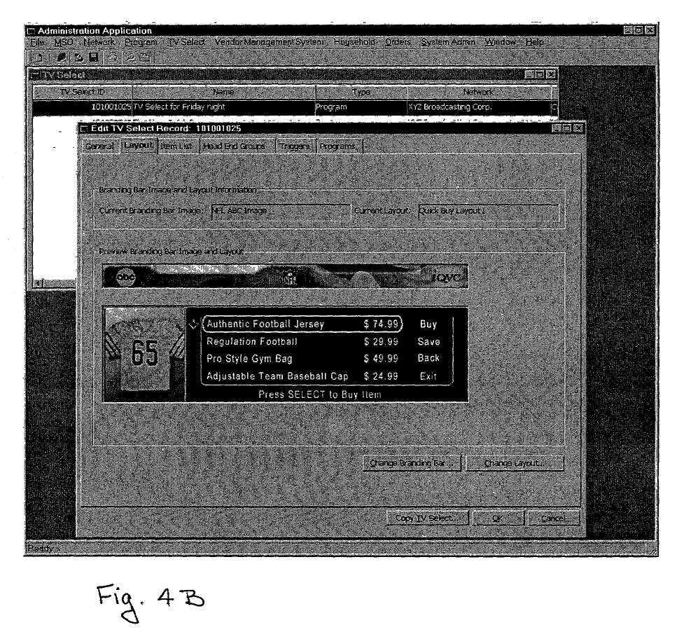

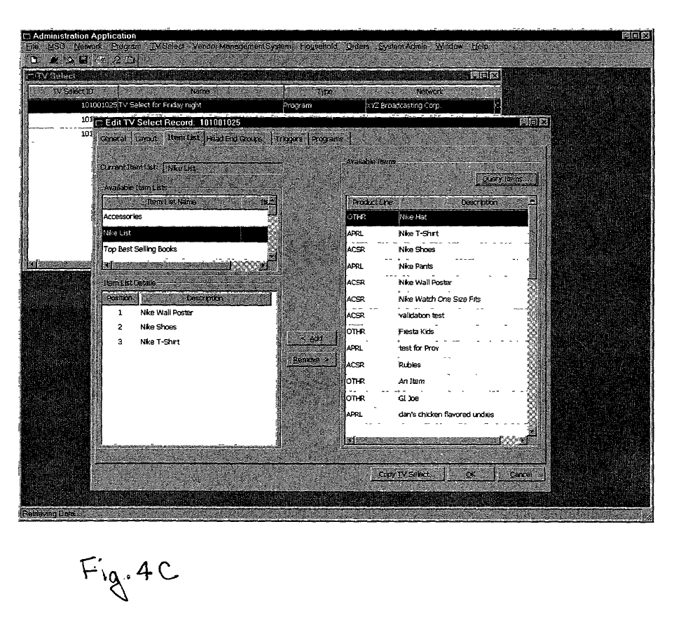

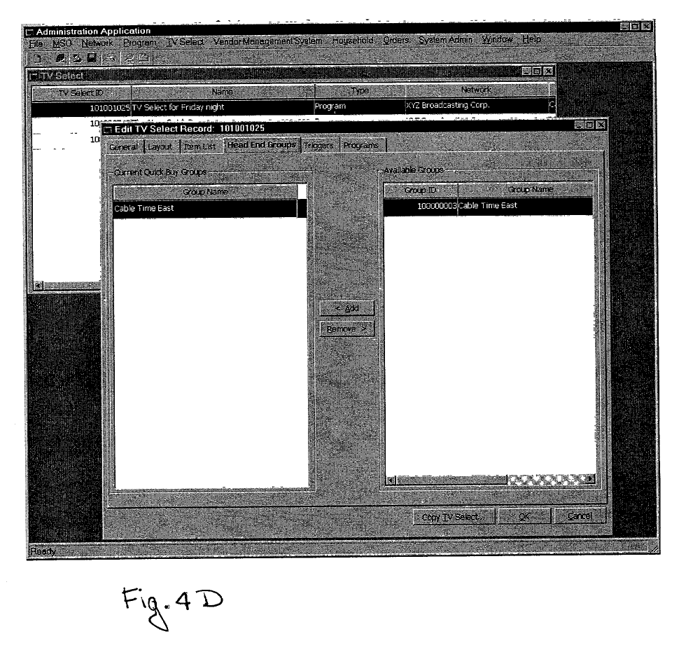

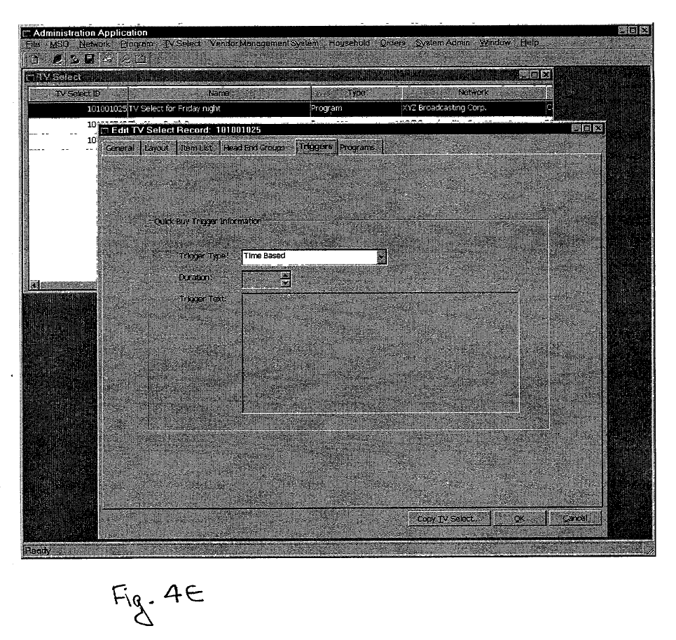

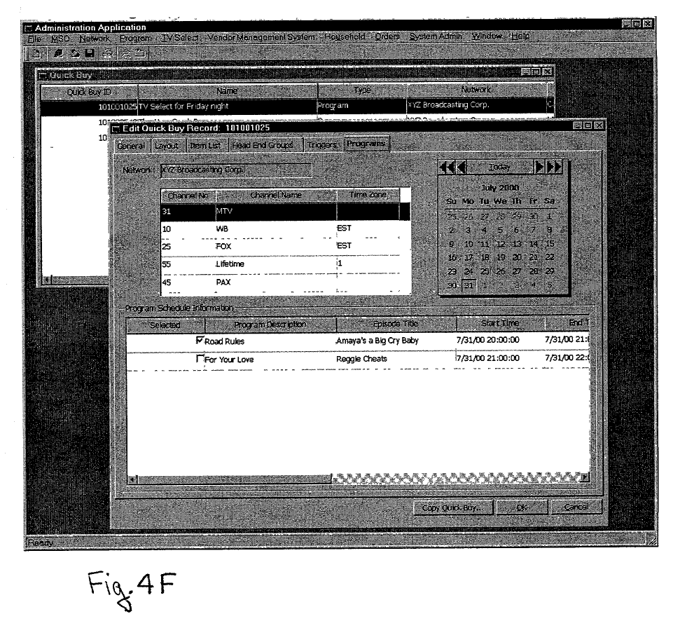

FIG. 4A shows one of the tab screens that the user will see when using the EBG application. The process of creating an enhancement definition, or EBG master, typically starts with identifying the network and MSO on whose program and system the enhancement will appear. The EBG application employs a hierarchical decision system such that alternatives presented later in the process will depend upon the user's initial choices, thereby eliminating alternatives that are inappropriate or invalid. For example, an initial choice of network and MSO will limit the choices available for enhancement features such as the on-screen branding bar. It would certainly not be appropriate, for example, to be able to choose an NBC logo for the branding bar if the program is provided by CBS.

As shown in FIG. 4A, the General tab screen gives the user the opportunity to define other features of the enhancement, including a name for the enhancement, a logo that will appear with the enhancement, and certain features of the logo, such as position, transparency and duration.

FIG. 4B shows the Layout screen, another tab screen that enables the user to choose an appropriate layout from the layouts provided by the authoring tool 1, and stored in the layout database 2. If there are customized layouts for a selected MSO or network that meet their specific stylistic requirements, than those layouts will be presented in the layout tab screen. Another definable feature shown on this screen is the branding bar, mentioned earlier, that can contain three trademarks to identify the network, the MSO and the vendor involved with the enhancement.

The Item List tab screen, FIG. 4C, allows the user to define a list of purchasable items that will be associated with the enhancement. The user can select an existing list that may be associated with one of various advertisers or programs, such as a Nike sport shoes or the NFL, modify an existing list by adding or deleting items, or create an entirely new list from available items in the purchasable items database 4. Each list has a name associated with it that will be included in the enhancement definition.

The Head End Groups tab screen, FIG. 4D, allows the application user to associate each enhancement with a particular head end, or group of head ends, of an MSO. This allows the user, through use of the geographic information in the program scheduling database 3, to target specific geographical groups of customers for particular enhancements. By this means, for example, two different enhancements can be shown to two different audience groups watching the same program. Although not implemented in the preferred embodiment, the capability exists to target individual viewers or viewer interest groups through use of the unique ID number that is associated with each set top box.

The Trigger tab screen, FIG. 4E, allows the application user to enter trigger information that will determine exactly when an enhancement will be activated at the set top box. As explained in greater detail below, enhancements are, in the present invention, broadcast through the programming distribution network in advance of the associated programming and stored in the set top boxes until activated at a specific time by a broadcast-based trigger. Trigger duration can be set to determine the length of time the corresponding enhancement will remain activated after the trigger is received.

The Programs tab screen, FIG. 4F, allows the EBG application user to assign programs to enhancements by selecting specific timeslots from a channel's schedule, each timeslot being defined in terms of a specific channel, start date and start time. Since timeslots are associated with channels, the user must first select the channel, then a date, or date range, and optionally a time range. The application will then display a list of programs scheduled to air on that channel within the date/time range, and one or more programs can be selected from the list for the enhancement. In the preferred embodiment, any particular enhancement can be associated with time slots on more than one channel, the only limitation being that the channels must be associated with the same network (e.g., NBC), which is selected before the time slots are selected.

As indicated earlier, the output product of the EBG application is an EBG master that defines the information to be incorporated in the corresponding enhancement. Each EBG master is essentially a collection of pointers to files that contain the details of the enhancement, including the layout, purchasable item list and channel/timeslot information. This scheme avoids unnecessary replication of detailed data that may be associated with more than one enhancement. The EBG masters and the detailed data necessary to support them are sent by the EBG application 5 to the CTP database 6. Preferably, this data is sent to the CTP database on a daily basis, and is limited to the enhancements scheduled to be downloaded to set top boxes the next day, so that storage space in the CTP database is conserved. Daily transmission also allows the data to reflect the most current program scheduling updates.

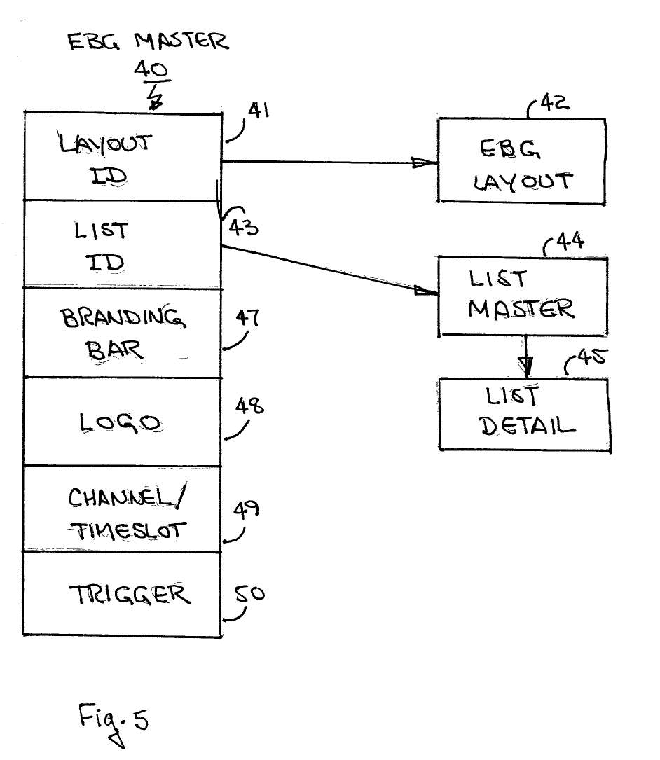

FIG. 5 shows the structure of an EBG master residing on the CTP database 6. Each EBG master 40 has a number of elements, which, as noted above, identify, or point to, data files in the CTP database containing the details of the element. For example, one of the elements is a Layout ID 41 that points to an EBG layout 42 in XML format containing specifications for the various appearance parameters of the enhancement, such as color and font style. There is also a List ID 43 that points to a List Detail 44 containing names and ID numbers of the items on the specified list that are being offered for purchase. The List Detail in turn points to Item Detail 45 regarding each of the items in the lists. The EBG master also contains pointers to image elements, such as the branding bar 47 and the vendor logo 48. With regard to scheduling, the EBG master contains reference to the relevant head end/channel/timeslot information 49 and trigger information 50.

Referring again to FIG. 1A, the Enhancement Packaging and Scheduling (EPS) service 7 is a software application running on a processor, whose functions are to periodically query the CTP database 6 to identify which enhancements need to be downloaded to the set top boxes in the immediate future, to retrieve from the CTP database the detailed data required for the identified enhancements, to assemble the enhancements and convert all of the elements of the enhancements to XML format, to validate the resultant XML code, and to send the completed enhancement on to the Data Streaming System (DSS) 8 at the appropriate time for downloading to the set top box boxes.

The first step in the process, as noted above, is for the EPS 7 to query the CTP database 6 as to which enhancements need to be prepared for downloading to set top boxes in the next interval. The length of that interval will depend of the time needed to process each enhancement and can be set dynamically to account for the volume of enhancements being processed. This first query returns a list of enhancements for each specific head end to which enhancements are to be sent. In the next step, the EPS retrieves from the CTP database, detailed files for those elements needed to assemble complete XML code for each enhancement in the list. The customized layouts, which are provided in XML format by the authoring tool 1, do not require conversion. Other elements, such as the item list and list detail, are, in the preferred embodiment, in Oracle database format and are converted to XML format using an Oracle XML parser. Picture elements, such as the vendor logo, branding bar and activation icon, which in the preferred embodiment have been generated in JPEG format, are converted to MIME format using a custom JAVA encoder, so the that they can be embedded in the XML code. After all of the elements of the enhancement have been assembled in XML format, the entire enhancement is validated using, in the preferred embodiment, the validation functions of the above-mentioned Oracle XML parser. The validation process confirms that each enhancement conforms to the applicable specification established for XML messages being sent the set top boxes, and hence ensures that each enhancement will behave appropriately when received and decoded. At the appropriate time in advance of activation, each enhancement that has been prepared by the EPS is sent by the EPS to the Data Streaming System (DSS) 8 to be downloaded in the appropriate broadcast channel. Thus, the EPS serves as a buffer to ensure that enhancement data is retrieved from the CTP database just in time to be processed and passed on to the DSS shortly before it is to be activated on the set top boxes, and hence, to ensure that none of the elements in the system are handing or storing more data that is really necessary.

In the preferred embodiment, the EPS resides on a Commerce Application Server (CAS) that is located at each cable system head end. The CTP database resides on a regional server that communicates with several CAS's, preferably via TCP/IP links. This distributed server architecture is described in greater detail in co-pending U.S. patent application Ser. No. 09/384,182, filed Aug. 27, 1999 (Attorney Docket 3011-02) having the same assignee as the present application, and whose content is incorporated herein by reference. However, the CTP database 6 and EPS 7 could easily be relocated to achieve the same functionality in a differently structured environment.

Referring again to FIG. 1A, the DSS 8 receives complete programming enhancements in the form of XML-formatted documents from the EPS 7. The role of the DSS 8 is to queue and broadcast the enhancements in a timely fashion to the set top boxes for which they are intended. The broadcasting of enhancements is done in the preferred embodiment via the vertical blanking interval (VBI) of the analog television signal in each channel, as explained in detail below. For digital systems, the broadcast enhancements can be inserted in a similar fashion into the MPEG data stream of each channel.

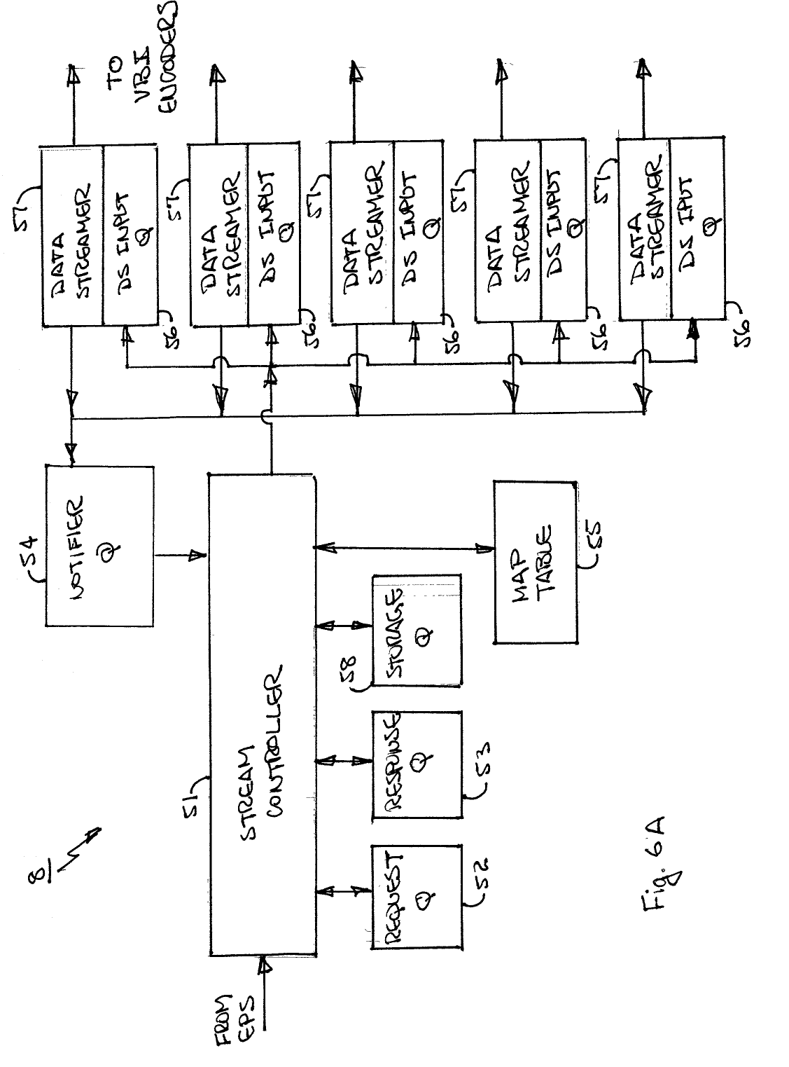

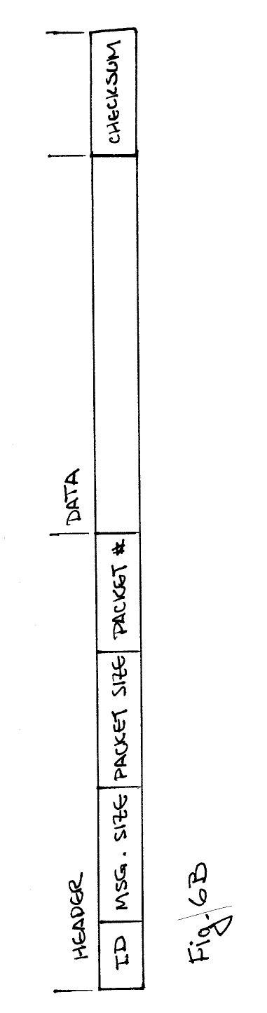

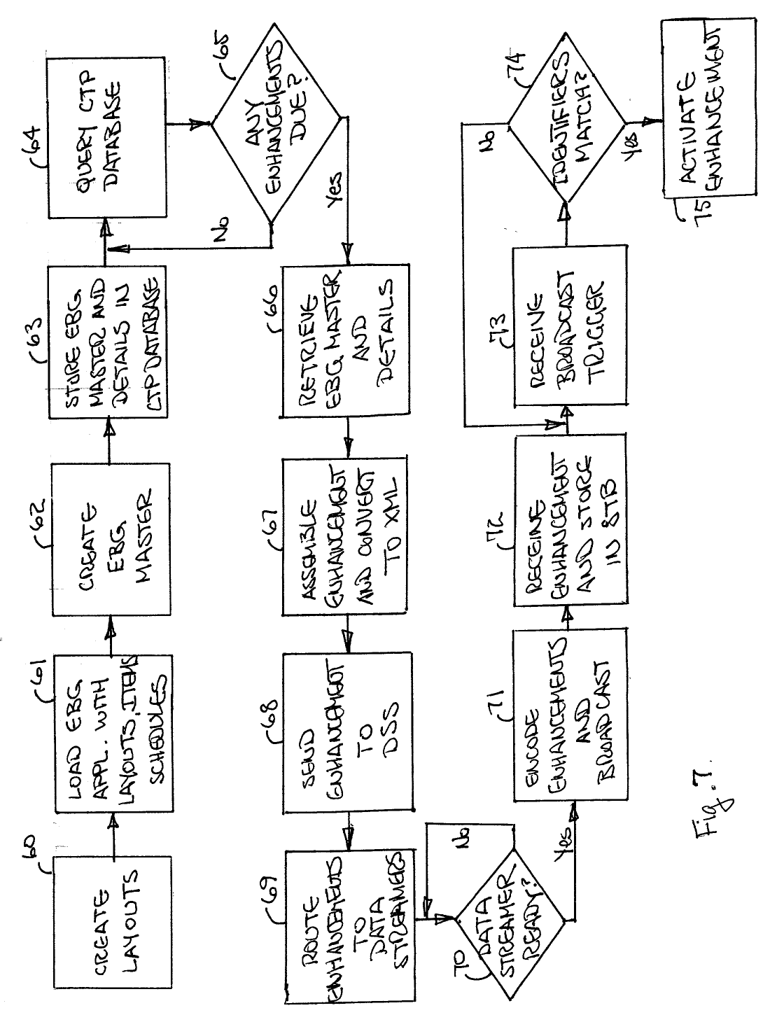

Referring to FIG. 6A, the DSS 8 includes a stream controller 51 connected to a number of data streamers 57. The stream controller and its related data streamers also preferably run on a CAS at each cable system headend. The stream controller 51 controls the overall process of the DSS. In the preferred embodiment, the stream controller is a Microsoft NT application that performs a number of functions. First, it receives the XML-formatted enhancements from the EPS 7 and queues up the enhancements in the data streamers in accordance with the respective destination of each enhancement. The stream controller keeps track of the status of each data streamer and buffers the XML messages until the particular data streamer is ready to accept it. It also starts up, shuts down and reassigns data streamers as required. Upon start-up, the stream controller informs each data streamer to which VBI encoder it is supposed to be connected and therefore, over which channel it will broadcast. The selected data streamer confirms by sending a registration message to the stream controller.

As shown in FIG. 6A, the stream controller sets up a number of message queues to effectively handle its functions. In the preferred embodiment, the queues make use of the Microsoft message queue (MSMQ) mechanism, a general purpose messaging scheme intended to assure communication between a sender and a receiver whether or not both are running at the same time. The data streamer system includes a number of message queues, all which are managed by the stream controller. The system includes a request queue 52, which contains messages from the EPS 7 requesting that specific enhancements be sent. A response queue 53 contains messages from the stream controller indicating whether the specific requests for broadcast of enhancements have been successful or not. A storage queue 58 stores the XML-formatted enhancements until such time as they are sent to the data streamers. A notification queue 54 receives messages from each data streamer as to the status of its ongoing data streaming process. The stream controller monitors the contents of the request queue and the notification queue to evaluate system performance and correct or restart the process as required. The stream controller also maintains a map table 55 that keeps track of which data streamer has been assigned to a particular enhancement and its current status.

Each data streamer 57 contains a data streamer input queue 56 that stores the XML-formatted enhancements forwarded by the stream controller pending transmission over the channel to which the data streamer is assigned. The stream controller 51 sends enhancements to each data streamer 57 in the order of their respective start times. If two enhancements destined for the same data streamer have the same start time, priority is given to the one with the shorter duration.

Referring again to FIG. 1A, each of the data streamers is connected to a VBI encoder 9 (such as the model TES3 manufactured by Norpak Corporation). Successful broadcast of an enhancement occurs when a data streamer indicates to the stream controller that a connection with a designated VBI encoder has been established and the enhancement has been sent to the encoder.

The vertical blanking interval (VBI) is the time it takes for an analog TV signal to retrace itself at the end of a picture field, that is, to move from the bottom of the screen back to the top of the screen. During the blanking interval, no active or viewable picture information is present. Both TVs and video displays position these lines off the top of the visible picture area. The vertical blanking interval lasts for a time equal to 21 horizontal lines of picture. These 21 lines typically contain information such as Vertical Interval Test Signals (VITS), Vertical Interval Reference Signals (VIRS), and Closed Captioning (CC). The present invention uses the vertical blanking interval to multicast in near real-time, enhancement data such as images, lists of products and item details. The present invention permits this type of data, regardless of its interval organization, to be broadcast using one or more lines of the vertical blanking interval. For this application, the in-band, vertical blanking interval provides superior performance to the out-of-band, TCP/IP and BFS (Broadcast File System) data paths provided by some of the more advanced digital TV distribution networks, such as the Scientific-Atlanta system. The TCP/IP path is not acceptable due to low bandwidth, and both TCP/IP and BFS are subject to shared use by other services. The VBI insertion technology allows for a theoretical transfer rate of 2.18 Kbytes per second. Using eight VBI lines yields an approximately 17 Kbytes per second transmission rate, a relatively high bandwidth that has the additional benefit of not interfering with the distribution system's other services.

Transmission of enhancements in the present invention via the VBI makes use of packetized data transmission. Each enhancement is broken up into packets, as shown in FIG. 6B, each of which has, in addition to the packet data, a header containing an enhancement ID and information about the total message size, packet size and packet number.

Referring again to FIG. 1A, the set top box 10 receives the packets, which are identified and reassembled into a complete enhancement message. By broadcasting the complete enhancement message more than once, bad or missing data packets can be replaced. The complete enhancement is stored in memory on the set top box. When an appropriate broadcast-based trigger is received, as explained in further detail below, the enhancement is activated and displayed on the screen of the TV receiver 11, simultaneously with the programming to which it is related. Alternatively, the enhancement can be unrelated to the programming being broadcast, and simply displayed during a specified time period.

FIG. 1B shows the parts of the system, according to the present invention, relating to the use of broadcast triggers for activation of enhancements that have been delivered to and stored in the set top boxes. As noted above with regard to the EBG Application 5 of FIG. 1A, the user can specify through the Trigger tab screen, a triggering method for the enhancement being created. The choices are either “Time” type, meaning that the set top box will use the start and end times specified in the enhancement to determine when the enhancement will be displayed, and “Trigger” (i.e., broadcast-based) type, meaning that the start and end times specified in the enhancement are only used to determine the period during which the enhancement is to be cached, but that the enhancement is not actually activated until a specific trigger is received by the set top box. For broadcast-based triggers, the Trigger tab screen also allows the user to specify a duration, a period of time after activation by the broadcast-based trigger during which the enhancement will remain available to the viewer. Specification of a duration assures that the enhancement will become inactive at or before the end of the program segment or commercial message to which it is related.

At the time an enhancement is being created using the EBG application 5 of FIG. 1A, the user can assign a unique identifier (i.e., a character string as described in more detail below) that is inserted into the data file that contains the enhancement. The Trigger tab screen has a Trigger Text window that allows the unique identifier to be included in the EBG Master. The unique identifier serves to identify the enhancement as being associated with a particular program. When the enhancement is broadcast via the Data Streaming System 8 of FIG. 1A, it will be stored in the set top box with the unique identifier.

Again referring to FIG. 1B, a programming source 12 broadcasts program material from a variety of sources, both live and pre-recorded, under the control of a broadcast automation system 14. As the programming is being broadcast, the automation system 14 also automatically causes trigger tool 16 (e.g. the RTG Trigger Generator from RespondTV, Inc., San Francisco, Calif. or the TV Link Creator from Mixed Signals Technologies, Inc., Culver City, Calif., each operating on a standard PC) to insert broadcast-based triggers at appropriate times into the vertical blanking interval of the broadcast signal using a VBI encoder 18. Each trigger contains the unique identifier of an enhancement that has been assigned to the particular program segment during which the trigger is broadcast. The association of a unique enhancement identifier with a particular program segment is established in the EBG master file, which includes for each enhancement both its unique identifier and the corresponding program ID that comes from the program scheduling database 3. At the programming source, each trigger is inserted at a time specified to the automation system 14 by the broadcaster's program schedule (commonly called a play list), which also makes reference to the program ID's. Alternatively, and particularly in the case of live programming, triggers may be inserted manually at the appropriate times using the trigger tool 16.

As previously noted, each broadcast enhancement with its unique identifier embedded in it is stored in a set top box awaiting the arrival of the corresponding program signal carrying a trigger with the identical identifier. The simultaneous presence at the set top box of the enhancement with its identifier and a trigger with an identical identifier causes the enhancement to be activated. The term “activation” means the appearance of an icon on the television screen, superimposed on the video portion of the program, indicating to the viewer that some informational content is available for him or her to view. When the viewer presses an appropriate button on his or her television remote control, this causes the entire enhancement to appear on the screen, waiting for the subscriber to further interact, perhaps by purchasing an item of merchandise, for example. Alternatively, the activation of enhancements can cause the entire enhancement to appear on the screen automatically, without the intervening appearance of the icon.

In a preferred embodiment of the present invention, each broadcast-based trigger is in the form of a text string that is compliant with the ATVEF (Advanced Television Enhancement Forum) specification. The Advanced Enhanced Content Specification, designed by a consortium of broadcast cable networks, consumer electronic companies, television transport operators and technology companies, defines a common, public standard for enhanced interactive television programming. This specification permits enhancements to be authored using a variety of tools and deployed to a variety of televisions, set top boxes and PC-based receivers. It facilitates the delivery of enhanced TV programming over both analog and digital video systems using terrestrial, cable, satellite and Internet networks.

As defined in the above referenced Advanced Enhanced Content Specification, a typical ATVEF-compliant trigger is text based and begins with a required URL (Uniform Resource Locator) enclosed in angle brackets (e.g., <http://xyz.com/fun.html>) followed by attribute/value pairs enclosed in square brackets, i.e.,

<url>[attr1:val1][attr2:val2] . . . [attrN:valN].

In the preferred embodiment of the present invention, the same URL serves as the unique identifier of the corresponding enhancement.

The attributes can be defined as needed. For example, the present invention provides for a unique attribute to differentiate between START and STOP triggers for the particular enhancement identified by the URL. A suitable attribute description would be “CTV” (in this case, indicative of the entity creating the enhancement in question) with two values: START and STOP. Thus, the “start” and “stop” trigger strings would begin respectively, as follows:

<url>[CTV:START] and

<url> [CTV:STOP].

Once the simultaneous presence of identical URL's in a stored enhancement and a START trigger is detected, the enhancement is activated and, preferably, an icon corresponding to the enhancement is immediately displayed of the television screen. The enhancement will remain activated until the set top box receives and detects a STOP trigger in the program signal that has a URL identical to the one embedded in the enhancement.

In the event that a STOP trigger is not subsequently received by the set top box, the duration specification in the enhancement, discussed above, will cause the enhancement to be de-activated automatically at the end of the specified duration period, thus assuring that the enhancement will not run over into the next program segment for which it was not intended.

A person of ordinary skill in the art will realize that broadcast-based triggers provide a flexible and powerful method of controlling program enhancements. The generation and use of broadcast-based triggers for broadcast television enhancements is discussed in detail in co-pending U.S. patent application Ser. No. 09/704,717, filed Nov. 3, 2000, having a common assignee with the present application and whose contents are incorporated herein by reference.

FIG. 6 is a flow chart that summarizes the method described above for creating and delivering program enhancements using the present invention. The process begins with step 60 for creating enhancements using the layout authoring tool. In step 61, the layouts generated by the authoring tool, as well as the purchasable items, and the programming schedules are loaded into the EBG application. These files are used in step 62 to create an EBG master defining the features of the enhancement including the layout, a list of items of purchasable items to be displayed in the enhancement, and the program, date, time with which the display of the enhancement are associated. In step 63, the enhancements, including the EBG master and the details, are stored for future use in this CTP database. At step 64, the EPS, the Enhancement Packaging and Scheduling service, queries the CTP database for the enhancements that will be broadcast in the next interval of time. If CTP returns a list of enhancement to be broadcast in that next time interval at step 65, then at step 66, the EPS retrieves the EBG master and details for the enhancements to be broadcast from the CTP database. In step 67, the EPS assembles the enhancements and converts their respective elements, including the layout, product data, and graphic features into a common XML format. At step 68, the assembled enhancements in XML format are sent to the Data Streamer System (DSS) for “just in time” delivery to the set-top boxes. At step 68, the DSS puts the enhancements into its storage buffer awaiting the availability of a data streamer to route the enhancements to the proper channels for broadcast the set-top boxes. If the data streamer is ready at step 70, then at step 71, the assigned data streamer encodes the enhancement to broadcast it to the set-top boxes over the appropriate channel of the TV distribution network. In step 72, the set-top box receives the enhancement and stores it in memory for display. At step 73, the set-top box receives a trigger broadcast with the programming to which the enhancement is related. Finally, if at step 74, the trigger and enhancement identifiers match, then at step 75, the enhancement is activated, and upon activation the enhancement is display. Otherwise the set top box continues to wait for a matching trigger.

It should be pointed out that enhancements may be created by various entities, such as the advertiser that creates a commercial being enhanced, the production company that creates the program, the network, a network affiliate, or a cable operator. Furthermore, depending on the nature of an enhancement, it might be intended for viewing by television viewers worldwide, only by viewers in certain geographical sections of the country, or perhaps only by viewers served by a particular cable operator head end. Therefore depending upon the attendant circumstances, it is possible that an enhancement may be introduced into the broadcast stream that ultimately is delivered to the set top boxes at various convenient points in the process. It is important to note that the system described herein for the creation and use of broadcast enhancements has broad applicability and is not limited to any particular programming distribution architecture.

Although the described embodiment utilizes the VBI stream within an analog video signal to deliver enhancements to set top boxes in a television distribution network, it will be apparent to a person of ordinary skill that the present invention is equally applicable with obvious modifications to the situation in which the video signal is digital.

It should be pointed out that the present invention can be used not only in the context of an enhancement that is associated with a particular television program, but also in the simpler case of an enhancement that is to be displayed on a dedicated television channel, i.e. a channel in a particular locality that does not carry regular television programming but which is used exclusively for the delivery of interactive enhancements. For example, this could be a shopping channel that displays enhancements in the form of catalog pages or merchandise menus that periodically change, perhaps on an hourly basis.

Although the present invention has been discussed within the context of a cable-based interactive television system, it could easily be applied to a satellite-based system, i.e. one in which the programming is communicated directly to the television STB via satellite. Nor is the invention necessarily limited to video broadcast systems; it is applicable to any other type of broadcast system (e.g., audio) where it is desired to make informational messages available to audience members. For example, instead of using a set top box and a television set, the basic invention could be implemented with any of a variety of consumer information appliances, i.e., individually addressable devices connectable to a network (either wired or wireless) that have a user interface, and which are capable of storing and executing programs and of displaying information. Such appliances include personal digital assistants, personal video recorders, pagers, telephones, personal computers, radios and Internet devices. The present invention is not to be limited in scope by the specific embodiments described herein. Various modifications will be readily apparent to those of ordinary skill in the art based on a review of the specification and drawings, and it is intended that such modifications fall within the scope of the following claims.

What is claimed is:

1. A system for defining program enhancements for use in an interactive broadcast network, comprising:
a first database containing information relating to available products;
a second database containing information relating to a plurality of layouts suitable for displaying product information on a television receiver screen;
a third database containing schedule information relating to television programs, including channel, date and time for broadcast for each of the programs; and
a processor configured to, in response to user inputs,
select, from the first database, a group of products having a relationship to a particular one of the scheduled programs;
select from the second database one of the plurality of screen layouts;
extract from the third database the schedule information relating to the one scheduled program; and
output an enhancement definition corresponding to the selected group of products, the one selected screen layout, and the extracted schedule information.

2. A system according to claim 1, wherein the processor is further configured to direct display of a graphical user interface to receive the user inputs with respect to information in the first, second and third databases.

3. A system according to claim 2, wherein the graphical user interface includes a plurality of user selectable screens for requesting user inputs.

4. A system according to claim 1, wherein at least one of the screen layouts in the second database includes facility for displaying a list of the selected group of products.

5. A system according to claim 4, wherein the at least one screen layout further includes facility for displaying detailed information in at least one of pictorial and textual form regarding a selected item from the displayed list products.

6. A system according to claim 1, wherein the processor is further configured to enable the user to add logos to the selected layout identifying at least one of a programming source, a broadcast system operator and a product vendor, and to include information relating to the logos in the enhancement definition.

7. A system according to claim 1, wherein the processor is further configured to enable the user to select by geographic region the channel over which the program enhancement is broadcast.

8. A system according to claim 1, wherein the processor is further configured to enable the user to select one or more additional scheduled programs to which the selected group of products is related, to extract from the third database scheduling information relating to the additional programs, and to associate the extracted information relating to the additional programs with the enhancement definition.

9. A system according to claim 1, wherein the schedule information in the third database is periodically updated.

10. A system according to claim 1, wherein the enhancement definition identifies a list of data files containing detailed information regarding the associated layout, group of products, and program schedule, the detailed information enabling display of an enhancement on the television receiver screen conforming to the enhancement definition.

11. A system according to claim 10, wherein the processor is further configured to output the data files with the enhancement definition.

12. A system according to claim 10, wherein the detailed information regarding the associated layout identifies a predetermined basic screen layout and modifications to the basic screen layout.

13. A method for defining program enhancements for use in interactive broadcast networks, comprising:
selecting from a database containing information related to available products, a group of products having a relationship to a particular scheduled program;
selecting from a database containing information relating to a plurality of layouts suitable for displaying product information on a television receiver screen, one of the screen layouts;
extracting from a database containing schedule information relating to television programs, schedule information relating to the channel, date and time for broadcast of the particular program; and
outputting an enhancement definition corresponding to the selected group of products, the one selected screen layout, and the extracted schedule information.

14. A method according to claim 13, wherein the selecting of a group of products, the selecting of one of the screen layouts, the extracting of schedule information, and the outputting of an enhancement definition are performed in response to inputs by a user by means of a graphical user interface.

15. A method according to claim 14, wherein the graphical user interface includes a plurality of user selectable screens for requesting user inputs.

16. A method according to claim 13, wherein at least one of the screen layouts in the database of screen layouts includes facility for displaying a list of the selected group of products.

17. A method according to claim 16, wherein the at least one screen layout further includes facility for displaying detailed information in at least one of pictorial and textual form regarding a selected item from the displayed list of products.

18. A system according to claim 13, further comprising:
adding logos to the selected layout identifying at least one of a programming source, a broadcast system operator and a product vendor; and
including information relating to the logos in the enhancement definition.

19. A method according to claim 13, further comprising:
selecting by geographic region the channel over which the program enhancement is broadcast.

20. A method according to claim 13, further comprising:
selecting one or more additional scheduled programs to which the selected group of products is related;
extracting from the database of program schedule information, schedule information relating to the additional programs; and
including in the enhancement definition, the extracted information relating to the additional programs.

21. A method according to claim 13, wherein the database of program schedule information is periodically updated.

22. A method according to claim 13, wherein the enhancement definition identifies a list of data files containing detailed information regarding the associated layout, group of products, and program schedule, the detailed information enabling display of an enhancement on the television receiver screen conforming to the enhancement definition.

23. A method according to claim 22, further comprising:
outputting the data files with the enhancement definition.

24. A system according to claim 22, wherein the detailed information regarding the associated layout identifies a predetermined basic screen layout and modifications to the basic screen layout.

25. An article of manufacture for defining program enhancements for use in an interactive broadcast network, comprising:
a computer readable medium;
computer programming stored in the medium;
wherein the stored computer programming is configured to be readable from the computer readable medium by a computer to thereby cause the computer to operate so as to, in response to user inputs:
select from a database containing information relating to available products, a group of products having a relationship to a particular scheduled program;
select from a database containing information relating to a plurality of layouts suitable for displaying product information on a television receiver screen, one of the screen layouts;
extract from a database containing schedule information relating to television programs, schedule information relating to the channel, date and time for broadcast of the particular program; and
output an enhancement definition corresponding to the selected group of products, the one selected screen layout, and the extracted schedule information.

26. An article of manufacture according to claim 25, further causing the computer to operate so as to:
direct display of a graphical user interface configured to receive user inputs with respect to information in the database containing information relating to available products, in the database containing information relating to a plurality of screen layouts, and in the database containing schedule information related to television programs.

27. An article of manufacture according to claim 26, wherein the graphical user interface includes a plurality of user selectable screens for requesting user inputs.

28. An article of manufacture according to claim 25, wherein at least one of the screen layouts in the database of screen layouts, includes facility for displaying a list of the selected group of products.

29. An article of manufacture according to claim 28, wherein the at least one screen layout further includes facility for displaying detailed information in at least one of pictorial and textual form regarding an item selected from the displayed list of products.

30. An article of manufacture according to claim 25, further causing the computer to operate so as to:
enable the user to add logos to the selected layout identifying at least one of a programming source, a broadcast system operator and an product vendor; and
include information relating to the logos in the enhancement definition.

31. An article of manufacture according to claim 25, further causing the computer to operate so as to:
enable the user to select by geographic region the channel over which the program enhancement is broadcast.

32. An article of manufacture according to claim 25, further causing the computer to operate so as to:
enable the user to select one or more additional scheduled programs to which the selected group of purchasable items is related;
extract from the database of program schedule information, schedule information relating to the additional programs; and
include in the enhancement definition, the extracted information relating to the additional programs.

33. An article of manufacture according to claim 25, wherein the database of program schedule information is periodically updated.

34. An article of manufacture according to claim 25, wherein the enhancement definition identifies a list of data files containing detailed information regarding the associated layout, group of products, and program schedule, the detailed information enabling display of an enhancement on the television receiver screen conforming to the enhancement definition.

35. An article of manufacture according to claim 34, further causing the computer to operate so as to:
output the data files with the enhancement definition.

36. An article of manufacture according to claim 34, wherein the detailed information regarding the associated layout identifies a predetermined basic screen layout and modifications to the basic screen layout.

37. A system for defining and delivering program enhancements in a broadcast programming network, comprising:
a first database containing information related to available products;
a second database containing a plurality of layouts suitable for displaying product information on a television receiver screen;
a third database containing schedule information relating to television programs, including channel, date and time for broadcast of each of the programs;
a first processor configured to, in response to user inputs,
select from the first database a group of products having a relationship to a particular one of the scheduled programs;
select from the second database one of the plurality of screen layouts; and
extract from the third database schedule information relating to the one program;
a second processor configured to direct the broadcast at a time prior to the time the particular program is scheduled to be broadcast, of a program enhancement including information related to the selected group of products and to the selected screen layout; and
a network terminal configured to receive the program enhancement and the one program, and to display the program enhancement to a viewer during the one program based on the broadcast enhancement information.

38. A system according to claim 37, wherein the screen layout selected for the broadcast program enhancement includes facility for displaying a list of the selected group of products.

39. A system according to claim 38, wherein the selected screen layout further includes facility for displaying detailed information in at least one of pictorial and textual form regarding an item selected from the displayed list of products.

40. A system according to claim 37, wherein the screen layout selected for the broadcast program enhancement is in the form of a translucent overlay on the television screen.

41. A system according to claim 37, wherein the screen layout selected for the broadcast program enhancement is in the form of an overlay that nominally covers the bottom one-third of the television screen.

42. A system according to claim 37, wherein the information included in the program enhancement relating to the selected screen layout identifies a predetermined basic screen layout and modifications to the basic screen layout.

43. A system according to claim 42, wherein the network terminal is further configured to store a copy of the basic layout, and to display the received program enhancement based on the information included in the received program enhancement identifying the basic screen layout and the modifications to the basic layout.

44. A system according to claim 37, wherein the second processor is further configured to convert the program enhancement into an XML document prior to broadcast, and the network terminal is further configured to convert the received XML-formatted enhancement into a form suitable for display to the television viewer.

45. A system according to claim 37, wherein the channel on which the program is broadcast carries an analog television signal, and the product information is broadcast via the vertical blanking interval of the analog television signal.
